(19) United States
(12) Patent Application Publication
(10) Pub. No.: US 2006/0241239 A1
(43) Pub. Date: Oct. 26, 2006

(54) Polyoxyalkylene amine-modified polyamideimide resin and composition thereof

(76) Inventors: Kuan-Yuan Hwang, Hsinchu (TW); An-Pang Tu, Hsinchu (TW); Sheng-Yen Wu, Hsinchu (TW)

Correspondence Address: FULBRIGHT AND JAWORSKI LLP, 555 S. FLOWER STREET, 41ST FLOOR, LOS ANGELES, CA, 90071, US

(21) Appl. No.: 11/373,738

(22) Filed: Mar. 9, 2006

(30) Foreign Application Priority Data
Mar. 16, 2005 (TW) 094107970

(51) Int. Cl. C08G 18/08; C08G 73/00

(52) U.S. Cl. 524/507; 528/170

(57) ABSTRACT

The present invention provides a polyoxyalkylene amine-modified polyamideimide resin and a polyamideimide resin composition includes said polyoxyalkylene amine-modified polyamideimide resin, a thermosetting resin and a rubber elastomer, and may further include an inorganic filler. The polyamideimide resin composition of the present invention has high heat resistance and high bond strength and can achieve sufficient adhesion at lower temperature, for example, 160 to 180° C. Thus, the resin composition of the present invention is suitable for use in bonding circuit boards and IC members.

### FIELD OF THE INVENTION

The present invention relates to polyamideimide resins, and more particularly, to polyoxyalkylene amine-modified polyamideimide resins.

### DESCRIPTION OF THE PRIOR ART

Recently, with the increasing demand for miniaturization of electronic devices and communication devices, the integrated circuit package therein tends to become smaller and thinner and circuits also become finer. Among various types of printed circuit boards, flexible printed circuit boards are widely used because they can make the volume and the weight of an electronic device greatly reduced.

Generally, a flexible printed circuit board comprises an insulating substrate and a metallic layer. The insulating substrate is bonded to the metallic layer by an adhesive. The metallic layer is usually consisting of a copper foil. Polyamideimide resins are widely used as insulating substrates due to their good heat resistance, chemical resistance, and excellent mechanical and electrical properties. The common adhesives for bonding the insulating substrate and the metallic layer are epoxy resins or acrylic resins. However, these adhesives have poor heat resistance and hence easily cause cracking during the sequential hot curing step of the resins, which in turn results in reduction of the dimension stability of the printed circuit boards.

Polyamideimide resins have excellent electrical and mechanical properties and high heat resistance and therefore are widely used as adhesives for printed circuit boards. For example, a mixture of a polyamideimide resin and a thermosetting resins has been applied onto the substrate of a printed circuit board and then dried to form an interlaminar adhesive layer. In order to bond an insulating substrate and a copper foil, the interlaminar adhesive layer should preserve flowability to adhere to the insulating substrate of the printed circuit board and to fill the depressions of the thickness of the copper foil made in the circuits. Therefore, drying of the coating must be carried out at low temperature so as not to cause thermal cure and lower the flowability of the adhesive layer.

In LSI (large scale integrated circuit)-packaging technology, chip size packages (CSP's) have been popularized because they permit reducing the mounting area of LSI to chip size. CSP's have shorter wire length and produce little inductance. Therefore, they can speed up and improve the performance of LSI's. and are advantagely applied in recent mobile phones or video cameras, and further in the DRAM of the personal computers.

There are various types of CSP, including wire-bonding type. Wire -bonding type CSP's are produced by connecting chips to polyimide wiring boards by wire-bonding and followed by sealing with resin. CSP of this type has simple structure and can be produced by modifying the conventional BGA technologies, and are expected to be the main current of CSP's.

CSP boards for wire-bonding type are produced by initially making through-holes in polyimide substrate coated with adhesives which can adhere to copper foil on heating, followed by lamination of copper foil by pressing or the like, circuit forming and gold plating. As the adhesives for bonding the polyimide substrate and the copper foil, epoxy resins, polyamic acids and mixtures of polyamic acids and bismaleimides have been used, while polyamideimide resins have been used mainly as wire coating material because of its excellent electrical and mechanical properties and high heat resistance. As CSP's have been downsized, the circuit of CSP boards has become finer, requiring heat resistance adhesives, which adhere to copper foil more strongly.

Among conventional adhesives, epoxy resins have poor resistance against wire bonding or solder reflow owing to lack of heat resistance. Polyamic acids and mixtures thereof with bismaleimides have excellent heat resistance, but need high curing temperature of 300-400° C. and their adhesion to copper foil or molded resin is insufficient. High temperature bonding process has disadvantages of expensive equipment cost and easier oxidation of copper foil.

In order to overcome the aforesaid problems, Hitachi Chemical Company has proposed a siloxane-modified polyamideimide resin, which can enhance thermal stability. However, its production cost is high and the polyamideimide resin has low reactivity with siloxane.

Polyamideimide resin compositions can provide strong adhesion between polyimide substrates and copper foils and hence are suitable for use as interlaminar adhesives. However, polyamideimide resin compositions having higher heat resistance and suitable for use in low temperature bonding process are still desired in packaging technologies.

### SUMMARY OF THE INVENTION

One object of the present invention is to provide a polyamideimide resin having high bond strength and a composition containing the same

Another object of the present invention is to provide a polyamideimide resin having high heat resistance and a composition containing the same.

A further object of the present invention is to provide a polyamideimide resin that can achieve sufficient adhesion at low temperature, for example, 160 to 180° C. and a composition containing the same.

In order to achieve the above objects, the present invention provides a polyoxyalkylene amine-modified polyamideimide resin, produced by reacting a mixture of a polyoxyalkylene amine and a multi-phenyl diamine compound with trimellitic anhydride to obtain a diimidodicarboxylic acid compound of formula (1): 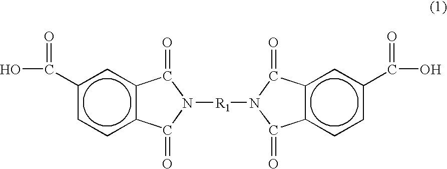
wherein R₁ is:

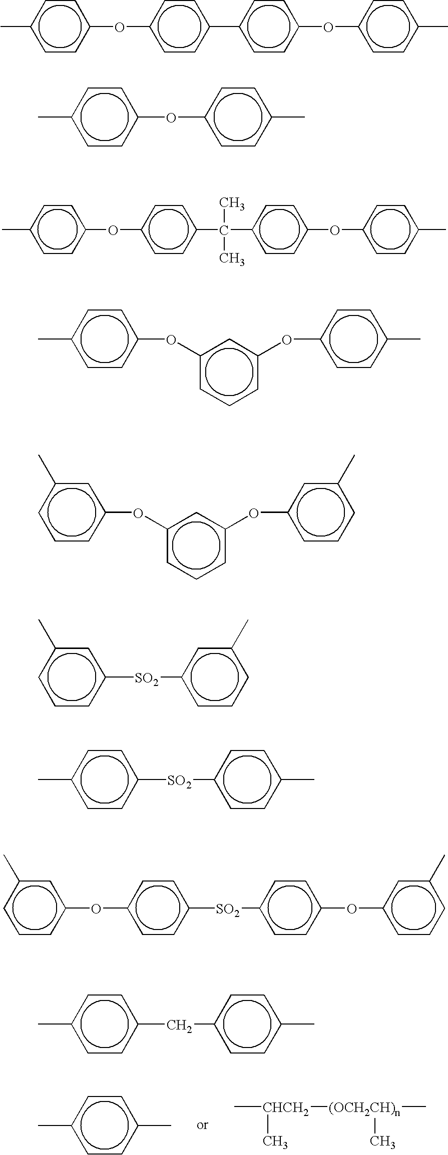

(wherein n is an integer of 2 to 3);
then reacting the diimidodicarboxylic acid compound of formula (1) with a diioscyanate compound of formula (2) 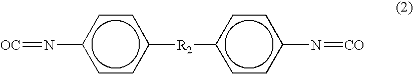
(wherein R₂ is a C₁₋₃ alkylene group)
to obtain a polyoxyalkylene amine-modified polyamideimide resin of formula (3):

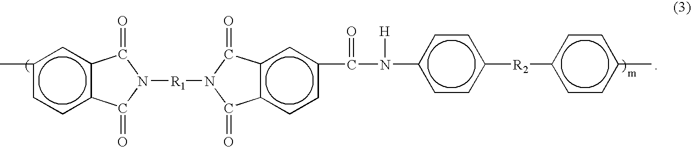

(wherein R₁ and R₂ are defined as above and m is an integer of 25 to 150).

The present invention further provides a polyamideimide resin composition comprising the aforesaid polyoxyalkylene amine-modified polyamideimide resin, a thermosetting resin and a rubber elastomer. The resin composition may further include an inorganic filler. The polyamideimide resin composition of the present invention has high heat resistance and high bond strength, and can achieve good adhesion at low temperature (for example, 160 to 180° C.). Thus, the resin composition of the present invention is suitable for use in bonding printed circuit boards and IC members.

### DETAILED DESCRIPTION OF THE PREFFERED EMBODIMENTS

The present invention will be illustrated by the following specific embodiments.

The present invention provides a polyoxyalkylene amine-modified polyamideimide resin, which is produced by reacting a diimidodicarboxylic acid compound of formula (1) 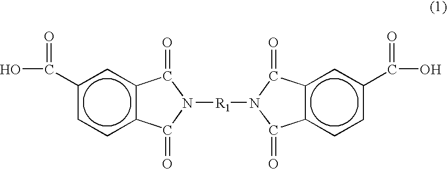
wherein R₁ is:

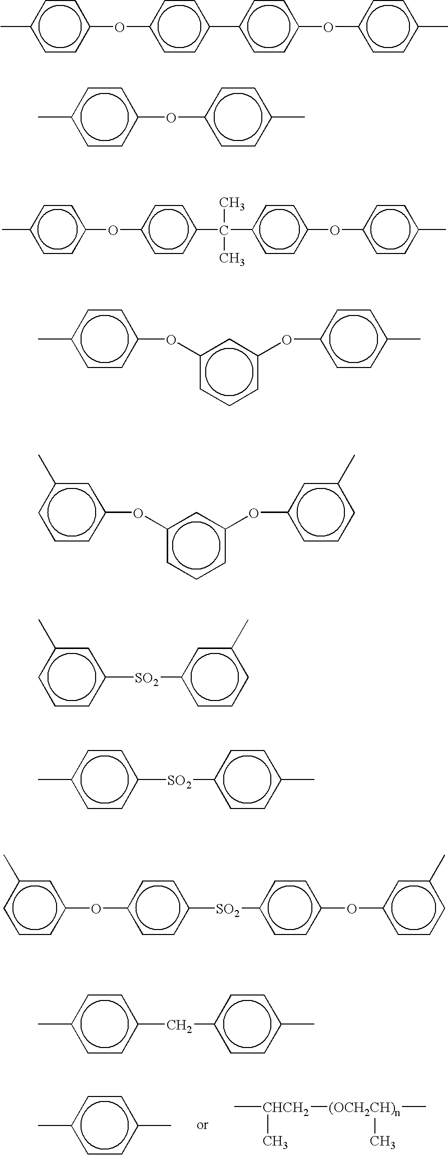

(wherein n is an integer of 2 to 3)
with a diioscyanate compound of formula (2):

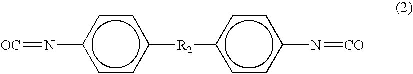

(wherein R₂ is a C₁₋₃ alkylene group, preferably a methylene group).

In one embodiment of present invention, the diimidodicarboxylic acid of formula (1) can be produced by reacting a mixture of polyoxyalkylene amine of formula (4):

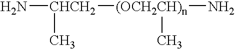

(wherein n is an integer of 2-3)

and a multi-phenyl diamine compound of formula (5):
H₂N—R₁′—NH₂ (5)

(wherein R₁′ has the same meaning as R₁ in formula (1) except R₁′ is not
—CH(CH₃)CH₂—(OCH₂CH(CH₃))ₙ—
with trimellitic anhydride (TMA), as shown in Scheme 1.

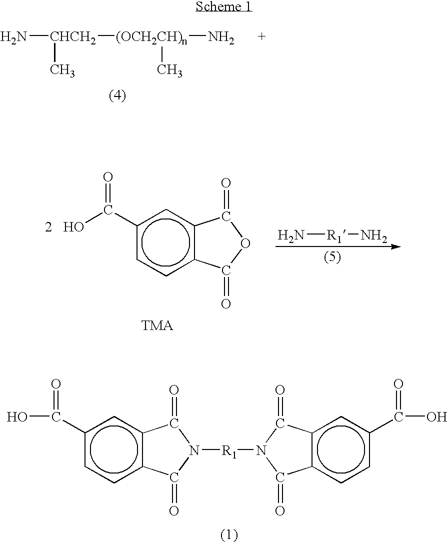

(wherein R₁, R₁′ and n are defined as above).

One preferred example of the multi-phenyl diamine compounds is 2,2-bis(4-(4-aminophenoxy)phenyl)propane of the following formula

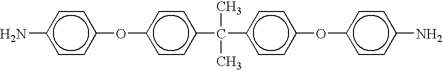

Polyoxyalkylene amine is commercially available and one example thereof is Jeffamine 230 (corresponding to the compound of formula (4) wherein n is an integer of 2 to 3 and its molecular weight is 230; sold by Huntsman company in America).

In one preferred embodiment of the present invention, the mixture of the polyoxyalkylene amine and the multi-phenyl diamine compound comprises 1 to 20 mol % of the polyoxyalkylene amine and 80 to 99 mol % of multi-phenyl diamine compound, based on the total weight of the mixture. Then, the diimidodicarboxylic acid compound of formula (1) is reacted with a diioscyanate compound of formula (2) to obtain a polyoxyalkylene amine-modified polyamideimide resin of formula (3), as shown in Scheme 2.

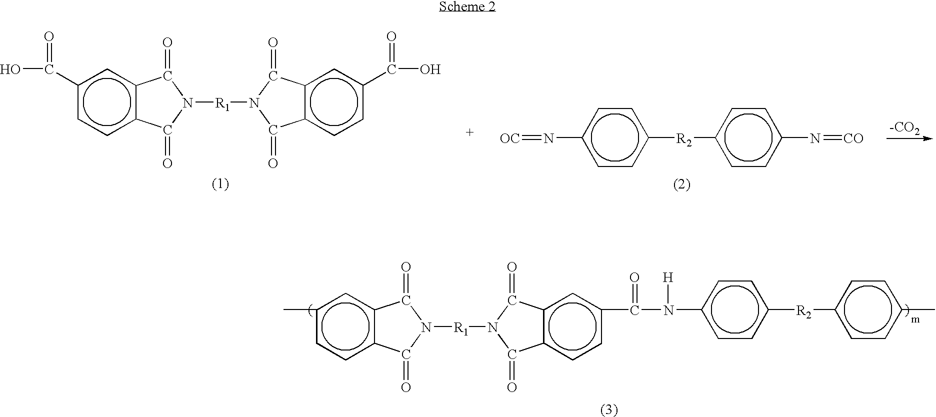

(wherein R₁ and R₂ are defined as above and m is an integer of 25 to 150).

The polyoxyalkylene amine-modified polyamideimide resin of the present invention has a molecular weight of 25,000 to 150,000 and preferably 50,000 to 120,000.

In an embodiment of the present invention, the polyoxyalkylene amine-modified polyamideimide resin is prepared by the following steps. A multi-phenyl diamine compound, such as BAPP, and a polyoxyalkylene amine are dissolved in an aprotic solvent, for example, N-methyl-2-pyrrolidone (NMP), N,N-dimethylacetamide (DMAC), N,N-dimethylformamide (DMF) and the mixtures thereof. Trimellitic anhydride (TMA) is added to the mixture and the reaction mixture is heated. The byproduct, water, is continuously brought out during reaction by azeotropic reflux with an organic solvent, for example, toluene. The intermediate polyamic acid (PAA) compound is thus formed through dehydration and ring closure reaction. The reaction continues until no more water is brought out. Toluene is then evaporated off and the reaction mixture is cooled to room temperature.

A diisocyanate compound, such as diphenylmethane diisocyanate (MDI), is added to the reaction mixture. The temperature of the reaction mixture is elevated slowly and it should be noticed that carbon dioxide bubbles are produced during reaction. After reaction for 2 hours, polyoxyalkylene amine-modified polyamideimide (PAI) resin is obtained.

The polyamideimide resin composition of the present invention includes 40 to 80 parts by weight of a polyoxyalkylene amine-modified polyamideimide resin, and 20 to 45 parts by weight of a thermosetting resin. The thermosetting resin can be an epoxy resin having 2 epoxy groups. The examples of the thermosetting resin include, but not limited to, phosphorus-containing epoxy resins, cresol-novolac resins, epoxy resins, epoxy resins, brominated epoxy resins and mixtures thereof.

The polyamideimide resin composition of the present invention may further include 5 to 30 parts by weight of a rubber elastomer and 0 to 15 parts by weight of an inorganic filler. The examples of the rubber elastomer include, but not limited to, acrylonitrile rubbers, butadiene rubbers, butadiene-acrylonitrile rubbers with carboxy end groups, butadiene-acrylonitrile rubbers with amino end groups, butadiene-acrylonitrile rubbers with epoxy end groups, polysiloxane rubber and the like. The examples of the inorganic filler include, but not limited to, silicon dioxide (SiO₂), aluminum oxide (Al₂O₃), aluminum hydroxide (Al(OH)₃), magnesium hydroxide (Mg(OH)₂), antimony oxide (Sb₂O₅), calcium carbonate (CaCO₃), magnesium carbonate (MgCO₃), calcium silicate (CaSiO₃), magnesium oxide (MgO), zinc oxide (ZnO), talc, mica, melamine pyrophosphate, melamine polyphosphate and the like.

The polyamideimide resin composition of the present invention may further include a curing agent. The examples of curing agents include, but not limited to, 2-ethyl-4-methyl imidazole and 2-methylimidazole (2-MI).

The polyamideimide resin composition of the present invention can be used as an adhesive for bonding resin substrates to copper foils in circuit boards, or as an adhesive in CSP. The polyoxyalkylene amine-modified polyamideimide resin of the present invention has good adhesion to copper foil and excellent heat resistance, in addition, sufficient adhesion can be achieved at low temperature, for example 160 to 180° C. Such low temperature bonding process (temperature: 160 to 180° C.; pressure: 50 to 200 kg/cm²) has advantages of less oxidation of copper foil and no necessity for expensive high-temperature laminating equipment, when compared with conventional high temperature bonding process (temperature: 300 to 380° C.; pressure: 50 to 200 kg/cm²). After bonding the resin substrate and the copper foil with the adhesive of the present invention, the resulting laminate is heated at 260° C. for 1 hour and then at 280° C. for 2 hours in an oven filled with nitrogen gas, to perform postcure; thereby a flexible printed circuit board with high heat resistance can be obtained. The features and effects of the present invention will be further described in the following Examples. However, it should be understood that the Examples are used to illustrate the present invention but by no means limit the scope of the present invention in any way.

### EXAMPLES

Starting Materials
polyoxyalkylene amine of formula (4):

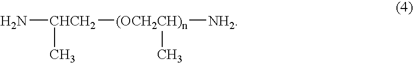

wherein n is an integer of 2 to 3.
BAPP: 2,2-bis(4-(4-aminophenoxy)phenyl)propane of formula: 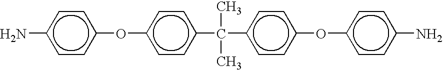
TMA: trimellitic anhydride
MDI: 4,4′-diphenylmethane diisocyanate 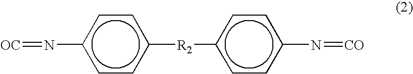
NMP: N-methyl-2-pyrrolidone
BE501: Bisphenol A Type epoxy resin, epoxy equivalent is 500, produced by Chang Chun Plastic Company.
Rubber: Nippon Zeon 1702 (butadiene-acrylonitrile with carboxy end groups)
2-MI: 2-methylimidazole

### Synthetic Example

A solution of BAPP (13.12 g, 0.032 moles) and polyoxyalkylene amine (1.84 g, 0.008 moles) in NMP (65 g) was charged into a 4-neck flask equipped with a stirrer. The mixture was stirred to make BAPP and polyoxyalkylene amine dissolved in the solution.

A solution of TMA (16.13 g, 0.084 moles) in NMP (25 g) was charged into the 4-neck flask and the reaction mixture was heated at a temperature of 80° C. for an hour. The flask was equipped with Dean Stark Apparatus and toluene (30 g) was added to the flask. The byproduct, water, was brought out by azeotropic reflux with toluene at 190° C. A diimidodicarboxylic acid compound was thus formed through dehydration and ring closure reaction. The reaction continued until no water was brought out. Toluene was then evaporated off and the reaction mixture was cooled to room temperature.

MDI (12 g, 0.048 moles) was added to the reaction mixture. The temperature was slowly raised to 190° C. and the reaction was performed at this temperature for 2 hours. Carbon dioxide bubble was produced during the reaction. Thereby, polyoxyalkylene amine-modified polyamideimide (PAI) resin was obtained.

### Example 1

73 g of the polyoxyalkylene amine-modified polyamideimide resin (solid content: 30%) obtained from Synthetic Example, 6 g of rubber (Nippon Zeon 1072 in NMP; solid content: 20%), 21 g of BE-501 and 0.5 g of 2-MI were added to a beaker and were stirred at 500 rpm for 20 minutes to make the mixture homogenous. At this time, the solid content of the resulting varnish was 41.4%. 4.14 g of talc (about 10% by weight based on the solid content of the varnish) was added to the varnish. Then, the mixture was stirred at 500 rpm for 30 minutes. The varnish was defoamed and stayed for 4 hours.

The varnish was applied to a copper foil and baked in an oven at 130° C. for 5 minutes and then at 180° C. for 10 minutes to remove the solvent. Thickness of the resin layer is 12.5 μm. Another copper foil was laminated on the resin layer at a temperature of 160° C. and a pressure of 100 kg/cm², and a laminate with a resin layer disposed between two copper foils was formed. The laminate was placed in an oven filling with nitrogen gas and baked at 260° C. for 1 hour and then at 280° C. for 2 hours to cure the resin layer. Thereby, a double-sided flexible circuit board with high bond strength and high heat resistance was formed.

### Examples 2-8

The double side flexible circuit boards in Examples 2-8 were produced by the same method of Example 1, except the raw materials and their amounts listed in Table 1 were used.

TABLE 1

| | Modified | | | | Total | Solid | |
|---|---|---|---|---|---|---|---|
| | PAI | BE501 | Rubber | 2-MI | weight of | content | Talc |
| Composition | (g) | (g) | (g) | (g) | varnish* | of varnish | (g) |
| Example 1 | 73.0 | 21.0 | 6.0 | 0.5 | 100 | 44.1% | 4.41 |
| Example 2 | 67.0 | 25.4 | 7.6 | 0.5 | 100 | 47.0% | 4.70 |
| Example 3 | 63.0 | 21.0 | 16.0 | 0.5 | 100 | 43.1% | 4.31 |
| Example 4 | 57.5 | 35.9 | 6.6 | 0.8 | 100 | 54.5% | 5.45 |
| Example 5 | 52.5 | 31.5 | 16.0 | 0.8 | 100 | 50.5% | 5.05 |
| Example 6 | 51.5 | 35.9 | 12.6 | 0.8 | 100 | 53.9% | 5.39 |
| Example 7 | 48.0 | 42.0 | 10.0 | 1.0 | 100 | 58.4% | 5.84 |
| Example 8 | 42.0 | 42.0 | 16.0 | 1.0 | 100 | 57.8% | 5.78 |

*Total weight of varnish the total weight of modified PAI, BE501 and rubber.

### Comparative Example

The double sides circuit board is produced by the same method of Example 1 except KS 6500 resin (from Hitachi Chemical company) was used to replace the polyoxyalkylene amine-modified polyamideimide resin of the present invention.

The circuit boards were tested for their bond strength to copper foil and heat resistance as follows and the results were reported in Table 2.

(1) Bond strength of copper foil: The test was performed according to IPC TM-650 2.4.9.

(2) Heat Resistance: The test was performed according to IPC TM-650 2.4.13.

TABLE 2

| | Bond Strength | Heat Resistance | Heat Resistance |
|---|---|---|---|
| | (kg/cm) | (288° C., 10 sec.) | (340° C., 10 sec.) |
| Example 1 | 1.32 | Pass | Pass |
| Example 2 | 1.28 | Pass | Pass |
| Example 3 | 1.33 | Pass | Pass |
| Example 4 | 1.59 | Pass | Pass |
| Example 5 | 1.67 | Pass | Pass |
| Example 6 | 1.74 | Pass | Pass |
| Example 7 | 1.83 | Pass | Pass |
| Example 8 | 1.94 | Pass | Pass |
| Compartive | 1.01 | Pass | Pass |
| Example | | | |

From Table 2, it can be seen that the circuit boards using the polyamideimide resin composition of the present invention as the adhesive have better adhesion between the copper foils and the substrates, and all circuit boards pass the heat resistance test.

The foregoing examples illustrate the principles and the effects of the present invention but does not intend to restrict the scope of the present invention in any way. Persons skilled in the art can make various modifications and changes to the Examples without departing the spirit and the scope of the present invention. The protection scope of the invention is defined by the Claims appended hereto.

What is claimed is:

1. A polyoxyalkylene amine-modified polyamideimide resin produced by reacting a diimidodicarboxylic acid compound of formula (1): 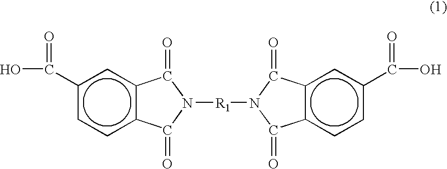
wherein R₁ is: 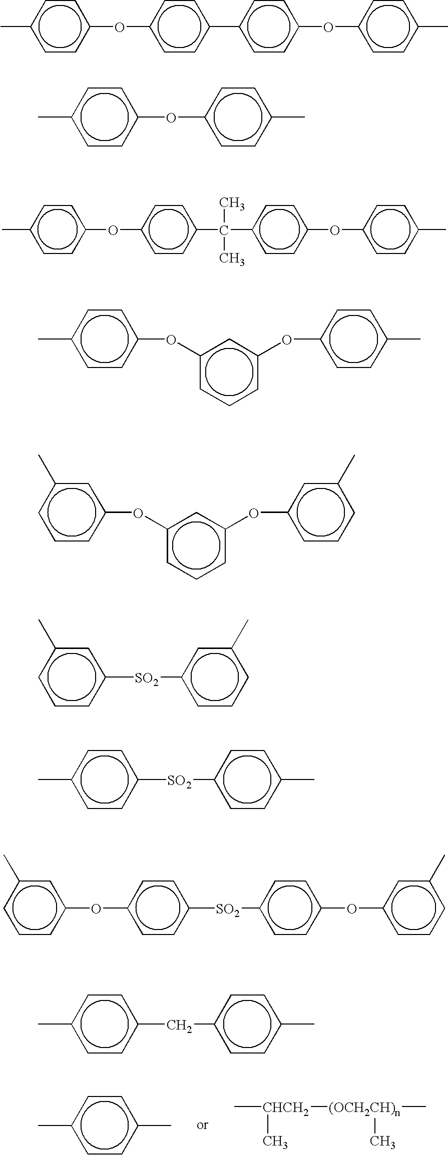
wherein n is an integer of 2 to 3)
with a diioscyanate compound of formula (2): 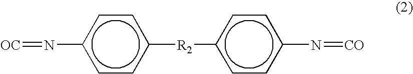
wherein R₂ is a C₁₋₃ alkylene group
to obtain a polyoxyalkylene amine-modified polyamideimide resin represented by formula (3): 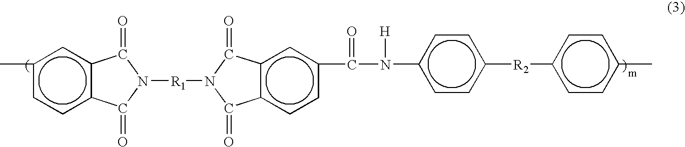
wherein R₁ and R₂ are defined as above and m is an integer of 25 to 150).

2. The resin according to claim 1, wherein R₂ is a methylene group.

3. The resin according to claim 1, wherein the diimidodicarboxylic acid compound of formula (1) is produced by reacting a mixture of a polyoxyalkylene amine and a multi-phenyl diamine compound with trimellitic anhydride.

4. The resin according to claim 3, wherein the polyoxyalkylene amine is 1 to 20 mol % and the multi-phenyl diamine compound is 80 to 99 mol %, based on the total weight of the mixture of the polyoxyalkylene amine and the multi-phenyl diamine compound.

5. The resin according to claim 3, wherein the polyoxyalkylene amine is represented by formula (4): 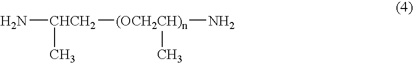
wherein n is an integer of 2-3).

6. The resin according to claim 3, wherein the multi-phenyl diamine compound is represented by formula (5):
H₂N—R₁′—NH₂ (5)
wherein R₁′ has the same meaning as R₁ in formula (1) as defined in claim 1, except R₁′ is not
—CH(CH₃)CH₂—(OCH₂CH(CH₃))ₙ—).

7. The resin according to claim 6, wherein the multi-phenyl diamine compound is

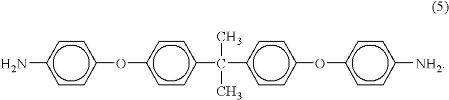

8. The resin according to claim 1, wherein the polyamideimide resin represented by formula (3) has a molecular weight of 25,000 to 150,000.

9. The resin according to claim 8, wherein the polyamideimide resin represented by formula (3) has a molecular weight of 50,000 to 120,000.

10. A polyamideimide resin composition comprising:
40 to 80 parts by weight of a polyoxyalkylene amine-modified polyamideimide resin as claimed in claim 1;
20 to 45 parts by weight of a thermosetting resin; and
5 to 20 parts by weight of a rubber elastomer.

11. The polyamideimide resin composition according to claim 10, further comprising 0 to 15 parts by weight of an inorganic filler.

12. The polyamideimide resin composition according to claim 10, wherein the thermosetting resin is an epoxy resin having 2 epoxy groups.

13. The polyamideimide resin composition according to claim 10, wherein the thermosetting resin is selected from the group consisting of a phosphorus-containing epoxy resin, a cresol-novolac resin, an epoxy resin, a brominated epoxy resin and a mixture thereof.

14. The polyamideimide resin composition according to claim 10, wherein the rubber elastomer is selected from the group consisting of an acrylonitrile rubber, a butadiene rubber, a butadiene-acrylonitrile rubber with carboxy end groups, a butadiene-acrylonitrile rubber with amino end groups, a butadiene-acrylonitrile rubber with epoxy end groups, a polysiloxane rubber and a mixture thereof.

15. The polyamideimide resin composition according to claim 11, wherein the inorganic filler is selected from the group consisting of silica, alumina, aluminum hydroxide, magnesium hydroxide, antimony oxide, calcium carbonate, magnesium carbonate, calcium silicate, magnesium oxide, zinc oxide, talc, mica, melamine pyrophosphate, melamine polyphosphate and the mixture thereof.

16. The polyamideimide resin composition according to claim 10, further comprising a curing agent.

17. The polyamideimide resin composition according to claim 16, wherein the curing agent is selected from the group consisting of 2-ethyl-4-methylimidazole and 2-methylimidazole.

18. A method for manufacturing a flexible print circuit board using the polyamideimide resin composition according to claim 9, comprising the steps of:
applying the polyoxyalkylene amine-modified polyamideimide resin composition according to claim 10 to a metal foil; and
removing the solvent by heating.

19. The method according to claim 18, further comprising the steps of:
laminating another metal foil on the polyoxyalkylene amine-modified polyamideimide resin layer applied on the metal foil in such a manner that the polyoxyalkylene amine-modified polyamideimide resin layer is between the two metal foils; and
curing the resin composition by heating to obtain a double-sided flexible print circuit board with a metal foil-resin-metal foil structure.

20. The method according to claim 18, wherein the metal foil is selected from the group consisting of a copper foil, an aluminum foil, a nickel foil and an alloy foil thereof.
